(19) United States
(12) Patent Application Publication
(10) Pub. No.: US 2012/0270040 A1
(43) Pub. Date: Oct. 25, 2012

(54) METHODS OF BONDING ARTICLES TOGETHER AND THE ARTICLES FORMED THEREBY

(76) Inventors: Joseph D. Rule, Cottage Grove, MN (US); Kevin M. Lewandowski, Inver Grove Heights, MN (US)

(21) Appl. No.: 13/514,143

(22) PCT Filed: Dec. 14, 2010
(86) PCT No.: PCT/US2010/060269

§ 371 Date: Jun. 6, 2012

Related U.S. Application Data
(60) Provisional application No. 61/288,404, filed on Dec. 21, 2009.

(51) Int. Cl. B29C 33/38; B32B 27/32

(52) U.S. Cl. 428/339; 264/219

(57) ABSTRACT

A method of bonding at least two articles together, the method includes forming a mold, wherein the mold is formed at least in part from the articles; and depositing a curable composition in the mold, wherein the curable composition polymerizes through metathesis polymerization to form a molded polymer joint that bonds the two articles together; and the article formed thereby. An article that includes a first portion; a second portion; and a molded polymer joint, wherein the molded polymer joint bonds the first portion to the second portion, the molded polymer joint has a thickness of at least about 1.3 mm, the molded polymer joint includes a metathesis polymer, and both the first and second portions have different compositions than the molded polymer joint.

### CROSS REFERENCE TO RELATED APPLICATION

This application claims the benefit of U.S. Provisional Patent Application No. 61/288,404, filed Dec. 21, 2009, the disclosure of which is incorporated by reference herein in its entirety.

### TECHNICAL FIELD

The present disclosure relates to methods of bonding articles using metathesis polymerization and the articles formed thereby.

### BACKGROUND

Numerous considerations can be utilized when bonding together particular substrates. The substrate materials, the necessary surface preparation, the cost of the bonding materials, and the strength of the bond can all play a role in choosing a method of bonding. Therefore, there always remains a need for additional methods of bonding that are inexpensive and that provide good bond strength for a variety of substrates.

### SUMMARY

Disclosed herein is a method of bonding at least two articles together, the method includes forming a mold, wherein the mold is formed at least in part from the articles; and depositing a curable composition in the mold, wherein the curable composition polymerizes through metathesis polymerization to form a molded polymer joint that bonds the at least two articles together.

Also disclosed herein is an article that includes a first portion; a second portion; and a molded polymer joint, wherein the molded polymer joint bonds the first portion to the second portion, the molded polymer joint has a thickness of at least about 1.3 millimeters (mm), and the molded polymer joint includes a metathesis polymer.

### BRIEF DESCRIPTION OF THE DRAWINGS

The disclosure may be more completely understood in consideration of the following detailed description of various embodiments of the disclosure in connection with the accompanying drawings, in which:

The figures are not necessarily to scale. Like numbers used in the figures refer to like components. However, it will be understood that the use of a number to refer to a component in a given figure is not intended to limit the component in another figure labeled with the same number.

FIGS. 1A, 1B, 1C, 1D, and 1E are schematic illustrations of exemplary disclosed articles.

### DETAILED DESCRIPTION

In the following description, reference is made to the accompanying drawing that forms a part hereof, and in which are shown by way of illustration several specific embodiments. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. As used in this specification and the appended claims, the term “or” is generally employed in its sense including “and/or” unless the content clearly dictates otherwise.

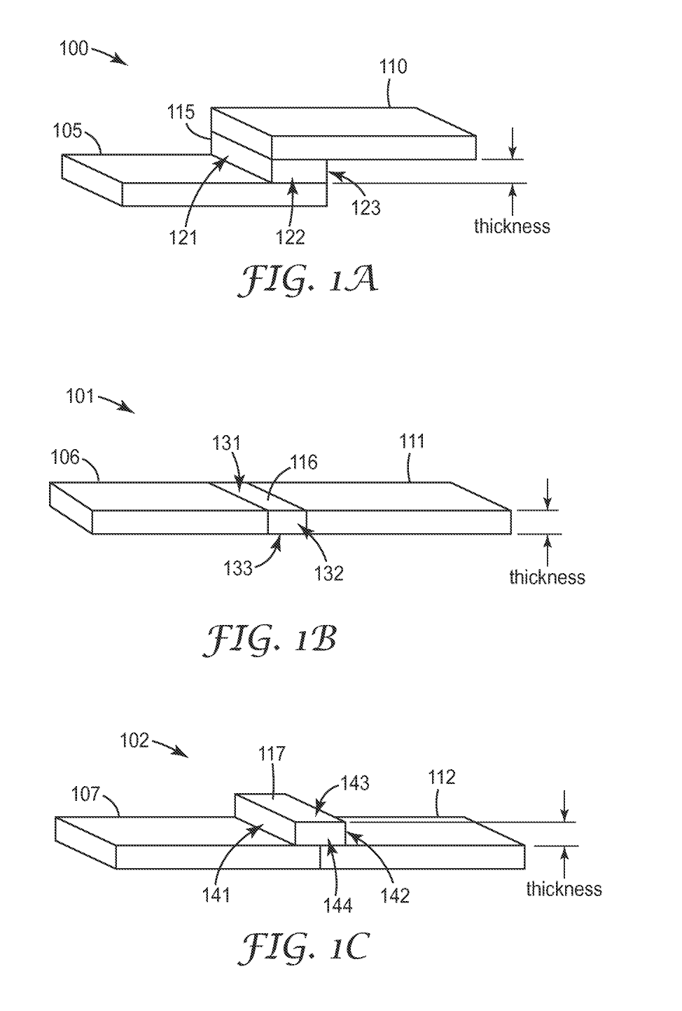

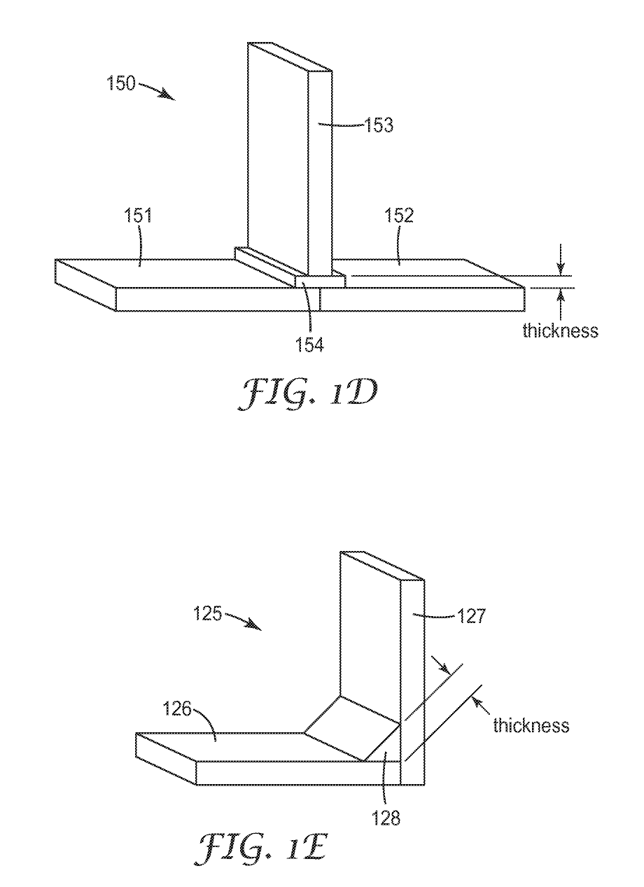

Disclosed herein are methods of bonding at least two articles together and the article formed thereby. An exemplary article as disclosed herein includes a first portion, a second portion, and a molded polymer joint that bonds the first portion to the second portion (or vice versa). FIG. 1A provides an example of an article disclosed herein. As seen in FIG. 1A, the article 100 includes a first portion 105, a second portion 110, and a molded polymer joint 115 that bonds the two portions together.

An article as described herein can include a first and second portion, or can include more than two “portions”. A “portion” of an article as used herein refers to articles which, absent the molded polymer joint would be independent, separate articles; or stated another way the molded polymer joint bonded the first portion (a first independent article) to the second portion (a second independent article) or vice versa. This can be exemplified by FIG. 1A, as seen there, the first portion 105 and the second portion 110 would be independent, separate articles, if not for the molded polymer joint 115. Discussion of “first and second portions” will be understood to apply equally to further portions (e.g., third portions, fourth portion, and fifth portion) that are included in the article. The first and second portions can generally have any shape or form.

Generally, the first portion, the second portion, or both the first and second portions have different compositions than the molded polymer joint. In embodiments, both the first and second portions have different compositions than the molded polymer joint. In embodiments, the first and second portions are made of the same material or have the same composition, which material or composition is different than that of the material or composition of the molded polymer joint. In embodiments, the first portion has a different composition (or is made of a different material) than the second portion, and both the first and second portions have different compositions (or are made of a different material) than the molded polymer joint. In embodiments where the article includes more than two portions, the materials or compositions of all of the portions can be the same or different, but at the very least the first and second portions have different compositions than the molded polymer joint (i.e., the third portion and any subsequent portions can be the same as the molded polymer joint).

The first and second portions can generally include any materials. In embodiments, the first and second portions are made of materials that are not metathesis polymers (which is described below). In embodiments, the first and second portions can independently be polyolefins. In embodiments, the first and second portions can independently be chosen from polypropylene, polyethylene, and SANTOPRENE™ thermoplastic elastomer (Exxon Mobil Chemical Company, Houston Tex.). In embodiments, the first and second portions can be made from the same material. In embodiments, the first and second portions can be made from different materials.

The first and second portions can generally have any thickness. In embodiments, the first and second portions can have a thickness of at least about 1 mm (about 40 mil). As used herein, the term mil refers to 0.001 inches. In embodiments, the first and second portions can have a thickness of at least about 60 mil. In embodiments, the first and second portions can have a thickness of at least about 1/16 inch (about 0.0625 inch, 1.6 mm or 62 mil). In embodiments, the first and second portions can have a thickness of at least about 120 mil. In embodiments, the first and second portions can have a thickness of at least about ⅛ inch (0.125 inch, 3.2 mm or about 125 mil).

Articles as disclosed herein also include a molded polymer joint. The molded polymer joint bonds the first and second portion of the article together. The molded polymer joint comprises a metathesis polymer. A metathesis polymer is a polymer that was polymerized (from a curable composition for example) through metathesis polymerization.

Metathesis polymerization involves the opening of a ring double bond and the formation of unsaturated linkages to adjacent monomer units. Metathesis polymerization of dicyclopentadiene (DCPD) into polydicyclopentadiene (pDCPD), as an example, is shown below:

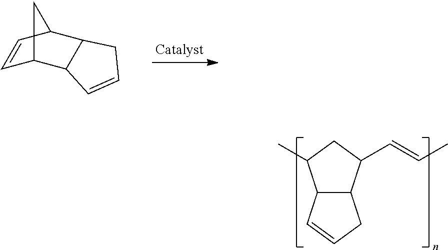

Metathesis polymerization of DCPD is often called a ring opening metathesis polymerization, or “ROMP”. Generally, crosslinking can occur during the polymerization reaction resulting in a thermoset polymer. The crosslinking may be due to a second metathesis reaction at the site of the less reactive cyclopentene ring (in the case of DCPD). Alternatively, crosslinking can occur due to addition polymerization of the pendant cyclopentene groups.

The molded polymer joint can include any polymer that was polymerized through metathesis polymerization. Exemplary monomers that can be polymerized by metathesis polymerization include strained cycloolefins. Strained cycloolefins have at least one ring having ring strain and a double bond. Strained cycloolefins can optionally include additional rings and double bonds. The rings may be fused or non-fused, spiro or bridging rings, and may be part of a larger ring system. Exemplary strained cycloolefins include cyclobutene, cyclopentene, cycloheptene, cyclooctene, cyclononene, cyclodecene, cyclododecene, norbornene, cyclooctadiene, cyclononadiene, 5-ethylidene-2-norbornene, 7-oxonorbornadiene, dicyclopentadiene, tricyclopentadiene, tetracyclopentadiene, norbornadiene, tetracyclo [6.2.1.1^{3,6}.0^{2,7}]dodeca-4,9-diene, and alkyl derivatives thereof.

The molded polymer joint can generally have a thickness of at least about 0.05 inch (about 1.3 mm). The molded polymer joint can have a thickness of at least about 0.058 inch (about 1.5 mm). In embodiments, the molded polymer joint can have a thickness of at least about 0.1 inch (about 2.5 mm). In embodiments, the molded polymer joint can have a thickness of at least about 0.2 inch (about 5.0 mm).

The molded polymer joint can have any useful bond area. The phrase “bond area” as utilized herein refers to the total area of contact between the molded polymer joint and the first and second portions. Generally, the bond area of the molded polymer joint can be chosen based at least in part on a number of factors, including for example, the identity of the first and second portions, the thicknesses of the first and second portions, the overall size of the first and second portions, the identity of the metathesis polymer making up the molded polymer joint, other components that may or may not be present in the material of the molded polymer joint, the thickness (bond line) of the molded polymer joint, or combinations thereof. In embodiments, the bond area can be increased in order to increase the force required for bond failure (bond failure refers to conditions where the molded polymer joint/portion interface will fail before either the first portion or second portion itself will fail).

The shape of the molded polymer joint can vary and can depend at least in part on the articles being bonded together. In embodiments, the shape of the molded polymer joint can also depend at least in part on the mold that may have been formed to create the molded polymer joint. In embodiments, the molded polymer joint can form typical types of joints, for example, the molded polymer joint can be similar to a butt joint or a patch joint.

FIGS. 1B and 1C show further examples of disclosed articles. The article 101 shown in FIG. 1B includes a first portion 106, a second portion 111, and a molded polymer joint 116. The molded polymer joint 116 in this embodiment could be considered to be similar to a butt joint. The article 102 shown in FIG. 1C includes a first portion 107, a second portion 112, and a molded polymer joint 117. The molded polymer joint 117 in this embodiment could be considered to be similar to a patch joint. As can be seen by the articles in FIGS. 1B and 1C, the two portions of the articles depicted there would not be joined but for the molded polymer joint.

FIG. 1D shows an example of a disclosed article. The article 150 shown in FIG. 1D includes a first portion 151, a second portion 152, a third portion 153, and a molded polymer joint 154. This example illustrates one configuration (of which numerous others are possible) where a molded polymer joint 154 can be utilized to bond more than two portions together to form an article.

It should also be noted that neither the molded polymer joint nor the portions of the article need be rectangular in shape. FIG. 1E shows an example of a disclosed article having a non rectangular molded polymer joint. The article 125 depicted in FIG. 1E includes a first portion 126, a second portion 127 and a molded polymer joint 128. As seen from FIG. 1E, the molded polymer joint 128 does not have a rectangular shape, but instead has a triangular prism shape. The thickness of the molded polymer joint 128 could be described by the length of the longest line that is both perpendicular to the largest surface of the polymer joint and that is entirely within the volume of the polymer joint. Molded polymer joints can also have configurations other than those depicted herein.

Articles as disclosed herein can also be further described by describing the orientation and configuration of the first and second portions with respect to the molded polymer joint. This can be accomplished, for example by describing the location of the first and second portions or the location of the molded polymer joint with respect to the first and second portions. In the exemplary articles shown in FIGS. 1A, 1B, 1C, and 1D the first portion and the second portion extend beyond the molded polymer joint (or the regions of the first and second portions that are in contact with the molded polymer joint) in opposing directions. In the exemplary article in FIG. 1D, the first portion, the second portion, and the third portion extend beyond the molded polymer joint. Such articles are different than an article where the polymer material covers substantially all, or all, of the articles that are being bonded together.

The articles depicted in FIGS. 1A, 1B, and 1C can also be further described by describing the position of the molded polymer joint with respect to the first and second portions. A bonded surface of a first or second portion is the surface (or surfaces) of the particular portion that is in contact with the molded polymer joint. A major surface of a first or second portion, as that phrase is utilized herein refers to a surface whose area is at least ⅙ of the overall surface area of the portion. A minor surface of a first or second portion, as that phrase is utilized herein refers to a surface whose area is not more than ⅙ of the overall surface area of the portion. A bonded major surface therefore refers to a major surface of a first portion that is contacted by the molded polymer joint and thereby bonded to a second portion, or vice versa. A bonded minor surface therefore refers to a minor surface of a first portion that is contacted by the molded polymer joint and thereby bonded to a second portion, or vice versa. Disclosed articles have at least part of the major surfaces of the first portion and the second portion that extend beyond the molded polymer joint. Stated another way, major surfaces of the first and second portions are not completely covered or completely contacted by the molded polymer joint.

For example, in the articles depicted in FIGS. 1A and 1B, the molded polymer joints (115 and 116) are positioned mostly between the first and second portions. In embodiments the molded polymer joint can be positioned substantially entirely or entirely between the first and second portions. In the article depicted in FIG. 1A, the molded polymer joint 115 is positioned mostly between major surfaces of the first and second portions. In embodiments, the molded polymer joint can be positioned substantially entirely or entirely between major surfaces of the first and second portions. In the article depicted in FIG. 1B, the molded polymer joint 116 is positioned mostly between minor surfaces of the first and second portions. In embodiments, the molded polymer joint can be positioned substantially entirely or entirely between minor surfaces of the first and second portions.

In the article depicted in FIG. 1C, the molded polymer joint is positioned almost entirely on surfaces of the first and second portions. In the particular embodiment depicted in FIG. 1C, the molded polymer joint 117 is positioned almost entirely on major surfaces of the first portion 107 and the second portion 112. The molded polymer joint 117 in the article depicted in FIG. 1C is configured so that a single surface of the molded polymer joint 117 contacts both the first portion 107 and the second portion 112. It should be noted that the minor surfaces of the first portion 107 and the second portion 112 under the molded polymer joint 117 can, but need not be in contact with each other. In embodiments where those minor surfaces are not in contact with each other or are not in complete contact with each other, the molded polymer joint may advance into the gap between the two articles.

In the article depicted in FIG. 1D, the article 150 exemplifies a configuration where major surfaces of the first portion 151 and the second portion 152 are bonded to a minor surface of the third portion 153. It should also be noted that the third portion 153 could be positioned differently so that a major surface of the third portion 153 could be bonded to major surfaces of the first and second portions 151 and 152 respectively. Other configurations of the three portions could also be possible and are contemplated herein.

In the article depicted in FIG. 1E, the article 125 exemplifies a configuration where major surfaces of the first portion 126 and the second portion 127 are bonded together. It should also be noted that other configurations and or further portions could be included in the article.

Methods of bonding two or more articles together are also disclosed herein. An exemplary method as disclosed herein includes the steps of forming a mold and depositing a curable composition in the mold. Another exemplary method as disclosed herein includes the steps of mixing a first and second composition to form a curable composition, heating at least a portion of first and second articles, and contacting the curable composition with at least a portion of the first and second articles. As both methods include curable compositions, details regarding the curable compositions will be discussed first.

A curable composition, as that phrase is utilized herein generally refers to a composition that can be polymerized by metathesis polymerization. A curable composition can generally include one or more monomers and a metathesis catalyst. Generally, the monomer can be any monomer that can be polymerized by metathesis polymerization. Monomers, such as those discussed above can be utilized in curable compositions. In embodiments a curable composition includes only one kind of monomer and in embodiments a curable composition includes two or more different kinds of monomers. The identities and amounts of the two or more monomers can be chosen at least in part based on desired properties in the final molded polymer joint.

The curable composition can include one or more than one metathesis catalyst. A metathesis catalyst or metathesis catalyst system can be formed from two separate components, a catalyst precursor portion and a catalyst activator portion. When using such a metathesis catalyst, the catalyst is not active until the two portions are brought together. Such a two part metathesis catalyst system is advantageously utilized when using reactive injection molding (RIM) methods, because one monomer stream containing the catalyst precursor portion (the first composition) can be brought into contact with a second monomer stream containing the catalyst activator portion (the second composition) and polymerization will not happen until the two compositions are mixed.

In embodiments, a one part metathesis catalyst, for example a ruthenium carbene catalyst (e.g. Grubbs I or Grubbs II) is not utilized herein. It is thought, but not relied upon that a two part metathesis catalyst allows the curable composition to reach a higher temperature during polymerization due to a high reaction rate of the two-part catalysts. Such a higher temperature, which can be referred to as an exotherm, may allow the polymer chains in the substrates (the articles to be bonded) to become more mobile and more strongly interact with the polymer chains formed in the molded polymer joint. Such interaction could enhance the bonding strength between the molded polymer joint and the articles being bonded.

Commonly known catalyst precursor portions may be utilized in first compositions as disclosed herein. Exemplary catalyst precursor portions may include tungsten (W) or molybdenum (Mo), and halides, oxyhalides, or oxides thereof. An exemplary catalyst precursor portion that may be utilized includes tungsten hexachloride (WCl₆).

Commonly known catalyst activator portions may be utilized in second compositions as disclosed herein. Exemplary catalyst activator portions may include trialkylaluminum compounds, dialkylaluminum halides, or alkylaluminum dihalides; organotin and organolead compounds; and tetraalkyltin compounds and alkyltin hydrides. An exemplary catalyst activator portion that may be utilized includes diethylaluminum chloride (Et₂AlCl or (C₂H₅)₂AlCl).

Alternatively, a one part metathesis catalyst can be utilized to obtain curable compositions, provided an appropriate exotherm (one that allows the polymer chains in the articles to be bonded to strongly interact with the polymer chains formed in the molded polymer joint) can be reached. Generally, such one part metathesis catalysts include W or Mo containing catalysts.

The choice of the particular metathesis catalyst (catalyst precursor portion and catalyst activator portion) and the amounts used may depend on the amounts and/or identities of monomers being used, the desired reaction conditions, the desired rate of cure, and so forth. In embodiments, the metathesis catalyst (the catalyst precursor portion and catalyst activator portion) can be included from about 0.001 wt % (weight percent) to about 10 wt % relative to the total weight of monomer(s). In embodiments, the metathesis catalyst (the catalyst precursor portion and catalyst activator portion) can be included from about 0.01 wt % to about 2 wt % relative to the total weight of monomer(s). Some, if not all of the catalyst precursor portions and catalyst activator portions are sensitive to ambient moisture and oxygen, so in embodiments, the reactive solutions are maintained under inert conditions. Once mixed, the curable composition may be injected into an air-filled mold as long as the polymerization is rapid and exposure to air is minimized. In embodiments, the mold can be purged with an inert gas such as nitrogen before introducing the curable composition. The polymerization can occur at room temperature, or heat can be used to help accelerate the polymerization.

The curable composition may optionally include other components. Such optional components can be introduced from the first composition, the second composition, or both. Additives can include chelators, Lewis bases, plasticizers, inorganic fillers, and antioxidants, for example phenolic antioxidants.

In embodiments for example, small amounts of water, alcohols, oxygen, or any oxygen-containing compounds may be added to increase the activity of the catalyst precursor.

The first composition containing the catalyst precursor portion, may be polymerized before being mixed with the second composition containing the catalyst activator portion. Addition of a chelator or a Lewis base stabilizer can minimize this possibility. Exemplary stabilizers include 2,4-pentanedione or benzonitrile. When stabilizers are added, they can be added at 50 mol % (mole percent) to 300 mol % relative to the catalyst precursor portion; and in embodiments from 100 mol % to 200 mol % relative to the catalyst precursor portion.

The second composition can also include optional additives. The addition of a Lewis base to the second composition can slow the gelation of the curable composition, thus allowing increased working time. The slower gelation of the curable composition may also provide additional time for the cycloolefinic monomer to penetrate the substrate surface and increase the interaction between the molded polymer joint material and the polymers of the first and second portions. An exemplary Lewis base for this purpose is butyl ether. Another exemplary Lewis base, which can be advantageously utilized because it can be polymerized into the molded polymer joint, is norborn-2-ene-5-carboxylic acid butyl ester. Another class of exemplary Lewis bases, which can be advantageously utilized because they act as plasticizers, include alkyl phthalates. The amount of Lewis base should be chosen to be sufficient to slow the gelation of the curable composition, but not to prevent a rapid exothermic cure. If a Lewis base is included, it can be added from about 0 mol % to 1000 mol % relative to the catalyst activator portion; and in embodiments from about 200 mol % to 500 mol % relative to the catalyst activator portion. Halogen-containing additives can also optionally be included. Such additives can increase the conversion of monomer during the polymerization. An exemplary halogen-containing additive is ethyl trichloroacetate. If halogen-containing additives are utilized, they can be included from about 0 mol % to 5000 mol % relative to the catalyst precursor portion; and in embodiments from about 500 mol % to 2000 mol % relative to the catalyst precursor portion.

Other optional additives can include plasticizers, organic or inorganic fillers, and antioxidants (for example phenolic antioxidants). Any such additional additives can be used in commonly utilized amounts. Generally such additives are used in amounts of less that 10 wt %, relative to the total amount of the curable composition.

The first composition and the second composition can optionally include solvents, and/or can be prepared utilizing solvents. Solvents can be included to aid in mixing of the compositions and/or dissolution of the components. In embodiments, it is desirable that substantially no solvent be included in the curable composition. If solvent was used to form the first composition, for example to aid in initially dissolving a component of the catalyst system, such as the catalyst precursor portion, it is desirable to remove the solvent under vacuum before forming the curable composition.

Once the curable composition is polymerized, it forms a molded polymer joint that includes a material formed with a metathesis catalyst. In embodiments, the material of the molded polymer joint includes a metathesis polymer and residue from the catalyst (and/or remaining catalyst). In embodiments for example, the material of the molded polymer joint can include a metathesis polymer and residual W or Mo that is derived from the catalyst.

Exemplary methods as disclosed herein include the step of forming a curable composition by mixing the first composition and the second composition. Mixing the first and second compositions can be accomplished before the curable composition is added to the mold or while the curable composition is being deposited in the mold, or a combination thereof. Mixing can be accomplished, for example by adding the first composition and the second composition (separately) to a mixer. In embodiments, an impingement mixer or a static mixer, for example can be utilized.

Once mixed, or while being mixed, the curable composition is deposited in a mold, where the curable composition polymerizes to form the molded polymer joint. In embodiments, the curable composition can be injected into a mold. In embodiments where the first composition and the second composition are mixed using a mixer, the mixer can be “in-line” with the mold and the curable composition can be deposited into the mold directly from the mixer. Commonly used systems and apparatuses for RIM can be utilized to accomplish mixing and deposition (or injection) of the curable composition into the mold.

Methods disclosed herein can include the step of forming a mold (or can utilize a mold). Molds as utilized herein are formed at least in part from the articles to be bonded. The articles to be bonded can optionally be modified or treated before or after they are formed into a mold. For example, the articles can be cleaned or surface treated, or both. In embodiments, the articles can be abraded, for example sanded, and cleaned with a solvent. Other methods of treating the articles can also be utilized.

The mold is formed from the articles to be bonded together and optionally other articles that will not be bonded. Forming a mold, as described herein can include combining the articles to be bonded with other components that will not be bonded, to form a void or a defined cavity, into which the curable composition can be deposited. The void or defined cavity is the mold that will ultimately form the molded polymer joint. The other components can be described as shims, and can simply close an open end of the cavity.

The mold can be formed to provide the desired dimensions of the molded polymer joint. For example, the mold can be formed so that a desired thickness of the molded polymer joint can be obtained. The articles to be bonded can form at least one interior surface of the mold. In embodiments, the articles to be bonded can form at least two interior surfaces of the mold.

The article depicted in FIG. 1A shows a first portion 105 and a second portion 110 that form two ends of the mold. Shims can be used to close three other ends, leaving only one end open to allow for the deposition of the curable composition. For example, the surfaces that are noted by the arrows 121, 122, and 123 can be closed using shims (not shown) leaving only the end opposite to surface 122 open for deposition of the curable composition. It should also be noted that a surface other than that opposite to surface 122 could be left open for deposition of the curable composition.

The article depicted in FIG. 1B shows a first portion 106 and a second portion 111 that form two ends of the mold. Shims can be used to close three other ends, leaving only one end open to allow for the deposition of the curable composition. For example, the surfaces that are noted by the arrows 131, 132, and 133 can be closed using shims (not shown) leaving only the end opposite to surface 132 open for deposition of the curable composition. It should also be noted that a surface other than that opposite to surface 132 could be left open for deposition of the curable composition.

The article depicted in FIG. 1C shows a first portion 107 and a second portion 112 that form one end of the mold. Shims can be used to close four other ends, leaving only one end open to allow for the deposition of the curable composition. For example, the surfaces that are noted by the arrows 141, 142, 143, and 144 can be closed using shims (not shown) leaving only the end opposite to surface 144 open for deposition of the curable composition. It should also be noted that a surface other than that opposite to surface 144 could be left open for deposition of the curable composition.

The articles depicted in FIG. 1D and 1E can also be formed from molds that can be formed using shims to close up all but one end. The articles depicted in FIG. 1A, 1B, 1C, 1D, and 1E can also be formed from molds that can be formed using shims that close up all the ends except for one or more small openings through which the curable composition or air can flow. Any configurations for forming such a mold could be utilized and is contemplated herein.

It should also be understood that the portions of the mold that are not being bonded by the molded polymer joint can be part of a structure that the articles to be bonded together can be placed into, thereby forming the mold. The portions of the mold that are not being bonded by the molded polymer joint can be made of a material that will not strongly bond to the curable composition. Exemplary materials include metals and glass as well as some polymeric materials such as for example, silicone, fluoropolymers, and polyesters. The mold can comprise a plurality of pieces in addition to the first and second portions that are all assembled to make the mold. Alternatively, a mold can comprise a single piece that is assembled with the first and second portions to make a mold.

The mold, or a portion thereof, once formed can optionally be heated before the curable composition is deposited therein. In embodiments, at least the portion of the mold that is made of the articles to be bonded can be heated. The mold can be heated to a temperature that is not high enough to thermally damage the articles to be bonded. In embodiments, the mold (or portion thereof) can be heated to a temperature that is above room temperature (about 25° C.). In embodiments, the mold (or portion thereof) can be heated to a temperature that is at least about 50° C. In embodiments, the mold (or portion thereof) can be heated to at least about 75° C. The mold (or portion thereof) can be heated using a heat gun, an oven, induction heating, infrared heating, microwave heating, or with direct-contact heating.

In methods of forming molded polymer joints that are optionally heated, the thickness of the molded polymer joint (or bondline) can be decreased in comparison to molded polymer joints that are formed without heating the articles to be bonded. In embodiments, the molded polymer joint can have a thickness of at least about 0.03 inch (about 0.76 mm). In embodiments, the molded polymer joint can have a thickness of at least about 0.05 inch (about 1.27 mm). In embodiments, the molded polymer joint can have a thickness of at least about 0.1 inch (about 2.54 mm).

In methods of forming molded polymer joints that are optionally heated to at least about 50° C. (and in embodiments to about 75° C.), the thickness of the molded polymer joint (or bondline) can be decreased in comparison to molded polymer joints that are formed without heating the articles to be bonded. In embodiments where the molded polymer joint was formed while being heated to at least about 50° C. (and in embodiments to about 75° C.), the molded polymer joint can have a thickness of at least about 0.03 inch (about 0.76 mm). In embodiments where the molded polymer joint was formed while being heated to at least about 50° C. (and in embodiments to about 75° C.), the molded polymer joint can have a thickness of at least about 0.05 inch (about 1.27 mm). In embodiments where the molded polymer joint was formed while being heated to at least about 50° C. (and in embodiments to about 75° C.), the molded polymer joint can have a thickness of at least about 0.1 inch (about 2.54 mm).

Once the curable composition cures, the articles (at least two) will be bonded together, with the cured curable composition functioning to bond the articles together. Two, or more than two articles can be bonded together using methods disclosed herein. Generally, curing of the curable composition will happen relatively quickly after deposition of the curable composition in the mold. In embodiments, the curable composition will be substantially cured in about 10 minutes or less.

Methods disclosed herein can also include steps of disassembling at least a portion of the mold after the curable composition has substantially cured. For example, the portions of the mold that are not made up of the articles to be bonded can be removed from the molded polymer joint. In embodiments where the articles to be bonded were placed into a structure containing the other portions of the mold, disassembly can be accomplished by removing the bonded article (containing the first portion, the second portion, and the molded polymer joint).

Another exemplary method as disclosed herein includes mixing a first composition and a second composition to form a curable composition, heating at least a portion of a first and second article, and contacting the curable composition with at least a portion of the first and second articles to form a bonded polymer joint that bonds the two articles together. The first composition, second composition and curable composition can be as discussed above. The method functions to bond a first article and a second article together. The first article and second article can be similar to articles discussed above to be bonded together.

Such methods include a step of heating at least a portion of the first and second article to a temperature above room temperature. In embodiments, at least the regions of the first and second article that will be in contact with the curable composition are heated to a temperature above room temperature (about 25° C.). In embodiments, at least the regions of the first and second article that will be in contact with the curable composition are heated to at least about 50° C. In embodiments, at least the regions of the first and second article that will be in contact with the curable composition are heated to at least about 75° C. The portions of the first and second article can be heated using a heat gun, an oven, induction heating, infrared heating, microwave heating, or with direct-contact heating.

Such methods also include a step of contacting the curable composition with at least a portion of the first and second articles to form a bonded polymer joint. Unlike the methods discussed above, this step does not need to, but can utilize a mold. This step can be accomplished by contacting the curable composition with the first article and then contacting the second article with the curable composition; by contacting the curable composition with the second article and then contacting the first article with the curable composition; or by contacting the curable composition with both the first article and the second article and then contacting the curable composition from the first and second articles with each other.

The articles to be bonded can optionally be modified or treated before the curable composition is contacted therewith. For example, the articles can be cleaned, surface treated, or both. In embodiments, the articles can be abraded, for example sanded, and cleaned with a solvent. Other methods of treating the articles can also be utilized.

Once the curable composition is cured, a bonded polymer joint is formed. The bonded polymer joint functions to bond the two articles together. The bonded polymer joint generally includes a polymer that was formed by metathesis polymerization of the curable composition.

The bonded polymer joint can generally have a thickness that is less than that of the molded polymer joint because at least a portion of the first and second articles are heated. Such heating can contribute to the joint bond strength by allowing the polymers of the articles to be bonded to entangle with the polymer of the bonded polymer joint. In embodiments, the bonded polymer joint can have a thickness of at least about 0.005 inch (about 0.13 mm). In embodiments, the bonded polymer joint can have a thickness of at least about 0.01 inch (about 0.25 mm). In embodiments, the bonded polymer joint can have a thickness of at least about 0.03 inch (about 0.76 mm).

Various items are provided that include a method of bonding and an article.

A first item is provided that is a method of boding at least two articles together. The method includes the steps of: forming a mold, wherein the mold is formed at least in part from the articles; and depositing a curable composition in the mold, wherein the curable composition polymerizes through metathesis polymerization to form a molded polymer joint that bonds the two articles together.

A second item is provided that can be a version of the first item. In the second item, the curable composition comprises a mixture of a first composition and a second composition wherein the first composition comprises a first monomer and a catalyst precursor portion, the second composition comprises a second monomer and a catalyst activator portion, the catalyst precursor portion and the catalyst activator portion together form a metathesis catalyst, and the first monomer and the second monomer can be the same or different.

A third item is provided that can be a version of the second item. In the third item, the first composition and the second composition are mixed either before the curable composition is deposited in the mold or while the curable composition is being deposited in the mold.

A fourth item is provided that can be a version of any one of the first to third items. In the fourth item, the method further comprises heating at least a portion of the mold before depositing the curable composition in the mold.

A fifth item is provided that can be a version of any one of the first to fourth items. In the fifth item, the method further comprises heating at least a portion of the mold to a temperature of at least about 50° C. before depositing the curable composition in the mold

A sixth item is provided that can be a version of any one of the first to fifth items. In the sixth item, the method further comprises heating at least a portion of the mold to a temperature of at least about 75° C. before depositing the curable composition in the mold

A seventh item is provided that can be a version of any one of the first to sixth items. In the seventh item, the step of forming the mold comprises forming a cavity with a thickness of at least about 1.3 mm.

An eighth item is provided that can be a version of any one of the first to seventh items. In the eighth item, the step of forming the mold comprises utilizing the articles to form at least one interior surface of the mold.

A ninth item is provided that can be a version of any one of the first to eighth items. In the ninth item, the step of forming the mold comprises utilizing the articles to form at least two interior surfaces of the mold.

A tenth item is provided that can be a version of any one of the first to ninth items. In the tenth item, the method further comprises disassembling at least a portion of the mold from the molded polymer joint.

An eleventh item is provided that can be a version of any one of the first to tenth items. In the eleventh items, the mold is configured so that the first portion and the second portion extend beyond the cavity to form the molded polymer joint in opposing directions.

A twelfth item is provided that can be a version of any one of the first to eleventh items. In the twelfth item, the first and second portions both have at least one major surface, and wherein the major surfaces of the first and second portions are not completely covered by the molded polymer joint.

A thirteenth item is provided that is an article. The article includes a first portion, a second portion, and a molded polymer joint. The molded polymer joint bonds the first portion to the second portion, the molded polymer joint has a thickness of at least about 1.3 mm, the molded polymer joint comprises a metathesis polymer, and both the first and second portions have different compositions than the molded polymer joint.

A fourteenth item is provided that can be a version of the thirteenth item. In the thirteenth item, the molded polymer joint comprises polydicyclopentadiene (pDCPD).

A fifteenth item is provided that can be a version of the thirteenth or fourteenth item. In the fifteenth item, the first portion and the second portion extend beyond the molded polymer joint in opposing directions.

A sixteenth item is provided that can be a version of any one of the thirteenth to fifteenth items. In the sixteenth item, the first portion and the second portion are a polyolefin.

A seventeenth item is provided that can be a version of any one of the thirteenth to sixteenth items. In the seventeenth item, the first portion and the second portion are each independently chosen from polypropylene, polyethylene, and a thermoplastic elastomer.

An eighteenth item is provided that can be a version of any one of the thirteenth to seventeenth items. In the eighteenth item, the molded polymer joint is positioned entirely between the first and second portions.

A nineteenth item is provided that can be a version of any one of the thirteenth to eighteenth items. In the nineteenth item, the molded polymer joint is positioned entirely between major surfaces of the first and second portions.

A twentieth item is provided that can be a version of any one of the thirteenth to nineteenth items. In the twentieth item, the molded polymer joint is positioned entirely between minor surfaces of the first and second portions.

A twenty-first item is provided that can be a version of any one of the thirteenth to twentieth items. In the twenty-first item, the molded polymer joint has a first surface and the first surface of the molded polymer joint contacts both the first portion and the second portion.

A twenty-second item is provided that can be a version of any one of the thirteenth to twenty-first items. In the twenty-second item, the molded polymer joint further comprises tungsten, molybdenum, or both.

A twenty-third item is provided that can be a version of any one of the thirteenth to twenty-second items. In the twenty-third item, the first and second portions both have at least one major surface, and wherein the at least one major surfaces of the first and second portions are not completely covered by the molded polymer joint.

A twenty-fourth item is provided that can be a version of any one of the thirteenth to twenty-third items. In the twenty-fourth item, the first portion has a different composition than the second portion, and both the first and second portions have different compositions than the molded polymer joint.

### Examples

Unless otherwise noted, all parts, percentages, ratios, etc. in the Examples and the rest of the specification are by weight.

### Bond Testing:

Tests were performed using a SINTECH load frame (commercially available from MTS Systems Corporation, Eden Prairie, Minn.) equipped with self-tightening grips and a 22,000 N maximum load cell. The samples were placed in the grips, and the grips were then separated at 2 inches (51 mm) per minute until sample failure. The peak load before sample failure was recorded. The length and width of the rectangular bond area was measured. The peak load was divided by this area to give the bond strength. For each sample set, at least three replicates were tested, and the average result for the sample set is reported.

### Preparatory Example 1

### Preparation of W Catalyst Solution

An oven-dried 500 mL flask under nitrogen was charged with WCl₆ (2.00 g, Sigma-Aldrich, St. Louis, Mo.), and about 100 mL of toluene (EMD/Merck, Darmstadt

Germany). This mixture was stirred for one hour while purging with nitrogen. Nonylphenol (1.1 grams, Sigma-Aldrich) was added via syringe and the solution was stirred for four hours with a nitrogen purge. Using a syringe, 2,4-pentanedione (0.77 grams, Acros Organics, Geel, Belgium) was then added, and the solution was stirred for 17 hours with a nitrogen purge. Dicyclopentadiene (250 mL, from TCI America, Portland, Oreg., and containing 4 wt % ethylidene norbornene and dried over molecular sieves) was added. The flask was placed in a 60° C. oil bath and vacuum was applied for 1.5 hours to remove the toluene (and other volatiles including some dicyclopentadiene). At that point, 106 mL of additional dicyclopentadiene was added to bring the total weight of the solution back up to 247 grams, and an additional charge of 2,4-pentanedione (0.77 grams) was added.

### Preparatory Example 2

### Dicyclopentadiene Reactive Resins

An oven-dried Erlenmeyer flask was capped with a septum and purged with nitrogen. Using a syringe, 223 mL of dicyclopentadiene was transferred to the flask. Ethyl trichloroacetate (2.1 mL, Sigma-Aldrich) and 75 mL of the catalyst solution from Preparatory Example 1 were then added.

Pentaerythritoltetrakis(3,5-di-tert-butyl-4-hydroxyhydrocinnamate) (1.90 grams, Sigma-Aldrich) and tris(2,4-di-tert-butylphenyl)phosphite (3.86 grams, TCI America) were placed in a separate oven-dried Erlenmeyer flask which was then capped with a septum and purged with nitrogen. Dicyclopentadiene (216.2 mL) and SANTICIZER261A (50 mL, phthalate plasticizer from Ferro Corporation, Bridgeport, N.J.) were added. The mixture was stirred for several minutes to dissolve the solids. 28 mL of a 10 vol % (volume percent) solution of diethylaluminum chloride (Sigma-Aldrich) in dicyclopentadiene was then added.

### Preparatory Example 3

### Dicyclopentadiene Reactive Resins

An oven-dried Erlenmeyer flask was capped with a septum and purged with nitrogen. Using a syringe, 18.7 mL of dicyclopentadiene was transferred to the flask. Ethyl trichloroacetate (0.25 mL) and 6.1 mL of the catalyst solution from Preparatory Example 1 were then added.

Pentaerythritoltetrakis(3,5-di-tert-butyl-4-hydroxyhydrocinnamate) (0.25 grams) was placed in a separate oven-dried Erlenmeyer flask which was then capped with a septum and purged with nitrogen. Dicyclopentadiene (22.2 mL) and butyl ether (0.19 mL, TCI America) were added. The mixture was stirred for several minutes to dissolve the solids. 2.3 mL of a 10 vol % solution of diethylaluminum chloride in dicyclopentadiene was then added.

### Example 1

### Overlap Shear with Polypropylene

Polypropylene sheets (7 inches×4 inches×¼ inch, 180 mm×100 mm×6 mm, Plastics International, Eden Prairie, Minn.) were sanded with 180 grit sandpaper and wiped with isopropanol. Two sheets were assembled with a shim system to create a defined cavity between the partially overlapped edges of the sheets. Various size cavities were tested as indicated in Table 1. Equal volumes of the two resins from Preparatory Example 2 were injected through a static mixer into the cavity (at room temperature (RT)) and allowed to cure. The sheets were then cut with a saw to give pairs of 1 inch×4 inches (25 mm×100 mm) coupons of polypropylene that were overlapped over a portion of their area and joined by a layer of metathesis polymer. The samples were tested to failure, and the results are shown in Table 1.

### Example 2

### Overlap Shear with Heated Polypropylene Substrates

The procedure in Example 1 was repeated, but the substrate assembly was heated to 50° C. or 75° C. prior to adding the resin. The results are summarized in Table 1 below.

TABLE 1

| | Bond Area | Bondline | Substrate | OLS | |
|---|---|---|---|---|---|
| Example | (mm × mm) | (mm) | T (° C.) | (MPa) | Failure Mode |
| 1a | 25 × 25 | 2.8 | RT | 5.0 | Substrate Failure |
| 1b | 25 × 25 | 1.5 | RT | 2.9 | Mixed: Adhesive and Substrate Failure |
| 1c | 25 × 25 | 0.8 | RT | 2.1 | Adhesive Failure |
| 1d | 25 × 25 | 0.4 | RT | 2.2 | Adhesive Failure |
| 1e | 25 × 13 | 2.8 | RT | 8.2 | Substrate Failure |
| 1f | 25 × 13 | 1.5 | RT | 3.9 | Adhesive Failure |
| 2a | 25 × 25 | 2.8 | 50° C. | 5.1 | Substrate Failure |
| 2b | 25 × 25 | 1.5 | 50° C. | 4.9 | Mixed: Adhesive and Substrate Failure |
| 2c | 25 × 25 | 0.9 | 50° C. | 4.6 | Mixed: Adhesive and Substrate Failure |
| 2d | 25 × 25 | 2.8 | 75° C. | 4.9 | Substrate Failure |
| 2e | 25 × 25 | 1.5 | 75° C. | 6.0 | Substrate Failure |
| 2f | 25 × 25 | 0.8 | 75° C. | 5.9 | Substrate Failure |

### Example 3

### Overlap Shear with Other Substrates

The general procedure in Example 1 was used with ⅛ inch (3.2 mm) thick LDPE (low density polyethylene), HDPE (high density polyethylene), UHMW-PE (ultra-high molecular weight polyethylene) and SANTOPRENE substrates (all from K-Mac Plastics, Wyoming, Mich.) that had not been sanded. The resin from Preparatory Example 3 was used. In all cases, the metathesis polymer thickness (i.e. bondline) was 0.12 inch (3 mm), the overlap area was nominally 1 inch×½ inch, (25 mm×13 mm) and the samples were prepared at RT. The results are summarized in Table 2.

TABLE 2
Overlap Shear on Varying Substrates

| | | OLS | |
|---|---|---|---|
| Example | Substrate | (MPa) | Failure Mode |
| 3a | LDPE | 1.9 | Substrate Failure |
| 3b | HDPE | 1.4 | Adhesive Failure |
| 3c | UHMW-PE | 0.7 | Adhesive Failure |
| 3d | Santoprene | 0.3 | Cohesive Failure of |
| | | | Santoprene |

Example 4

### Overlap Shear with LDPE and Shorter Bondline

Example 3 was repeated, but the metathesis polymer thickness (i.e. bondline) was reduced to 0.06 inch (1.5 mm). In this case, the OLS (overlap shear) was 1.1 MPa and the sample failed by adhesive failure.

### Comparative Example 5

### Overlap Shear with Polypropylene and Ruthenium Catalyst

Example 1a was repeated, but the resin was prepared by adding 0.05 grams of Grubbs First Generation Catalyst (Sigma-Aldrich) in a solution with 0.5 mL toluene to a solution comprising 22.5 mL DCPD, 2.5 mL SANTICIZER 261a, 0.08 grams of pentaerythritol tetrakis(3,5-di-tert-butyl-4-hydroxyhydrocinnamate) and 0.17 g of tris(2,4-di-tert-butylphenyl)phosphite. The average shear strength was 1.1 MPa, and the samples underwent adhesive failure.

### Example 6

### Butt Joint

One 7 inches×¼ inch (180 mm×6 mm) edge of polypropylene sheets (7 inches×4 inches×¼ inch, 180 mm×100 mm×6 mm) was sanded with 180 grit sandpaper and wiped with isopropanol. Glass plates and silicone sheets were used to create a cavity about 6 inches×0.5 inch×¼ inch (about 150 mm×13 mm×6 mm) between the sanded edges of two polypropylene sheets. Equal volumes of the two resin components from Preparatory Example 2 were then injected through a static mixer into the cavity. After the resin had cured, the glass and silicone were removed. The sample was cut into 1 inch (25 mm) wide strips. This final test specimen was two 1 inch×4 inch (25 mm×100 mm) polypropylene coupons joined by a 0.5 inch (13 mm) long section of metathesis polymer to create a flat assembly roughly 8.5 inches×1 inch×¼ inch (220 mm×25 mm×6 mm). The samples were tested to failure, and the average peak load for twelve specimens was 1700 N. The samples underwent adhesive failure.

### Example 7

### Patch Joint with Polypropylene

The surface of polypropylene sheets (7 inches×4 inches×⅛ inch, 180 mm×100 mm×6 mm) was sanded with 180 grit sandpaper and wiped with isopropanol. Two polypropylene sheets were set edge-to-edge along a 7 inches (180 mm) edge. Glass plates and silicone sheets were used to create a cavity about 6 inches×1 inch×⅛ inch (about 150 mm×25 mm×3 mm) that bridged the seam of the two sheets. Equal volumes of the two resin components from Preparatory Example 2 were then injected through a static mixer into the cavity. After the resin had cured, the glass and silicone were removed. The sample was cut into 1 inch (25 mm) wide strips. This final test specimen was two 1 inch×4 inches×⅛ inch (25 mm×100 mm×3 mm) polypropylene coupons in the same plane with a 1 inch×1 inch×⅛ inch (25 mm×25 mm×3 mm) layer of metathesis polymer bonded to the top surface of the two polypropylene coupons. The samples were tested to failure, and the average peak load for eleven specimens was 1000 N. The samples underwent adhesive failure.

### Example 8

### Patch Joint with LDPE

The process in Example 7 was repeated using LDPE instead of polypropylene and using the resin from Preparatory Example 3. The average peak load for three specimens was 790 N. The samples underwent substrate failure of the LDPE.

Thus, embodiments of methods of bonding articles and the articles formed thereby are disclosed. One skilled in the art will appreciate that the present disclosure can be practiced with embodiments other than those disclosed. The disclosed embodiments are presented for purposes of illustration and not limitation, and the present disclosure is limited only by the claims that follow.

1. A method of bonding at least two articles together comprising the steps of:
forming a mold having a cavity with a thickness of at least about 1.3 millimeters, wherein the mold is formed at least in part from the articles;
depositing a curable composition in the mold, wherein the curable composition comprising (a) a monomer, (b) a catalyst precursor comprising tungsten, molybdenum, or both, and (c) a catalyst activator; and
polymerizing the curable composition through metathesis polymerization to form a molded polymer joint that bonds the two articles together, wherein each of the two articles comprises a thermoplastic selected from polyolefin or an elastomer.

2. A method according to claim 1, wherein the curable composition comprises a mixture of a first composition and a second composition wherein the first composition comprises a first monomer and the catalyst precursor, the second composition comprises a second monomer and the catalyst activator, the catalyst precursor and the catalyst activator together form a metathesis catalyst, and the first monomer and the second monomer can be the same or different.

3. The method according to claim 2, wherein the first composition and the second composition are mixed either before the curable composition is deposited in the mold or while the curable composition is being deposited in the mold.

4. The method according to claim 1 further comprising heating at least a portion of the mold before depositing the curable composition in the mold.

5. The method according to claim 1 further comprising heating at least a portion of the mold to a temperature of at least about 50° C. before depositing the curable composition in the mold

6. The method according to claim 1 further comprising heating at least a portion of the mold to a temperature of at least about 75° C. before depositing the curable composition in the mold

7. (canceled)

8. The method according to claim 1, wherein the step of forming the mold comprises utilizing the articles to form at least one interior surface of the mold.

9. (canceled)

10. The method according to claim 1 further comprising disassembling at least a portion of the mold from the molded polymer joint.

11. The method according to claim 1, wherein the mold is configured so that the first portion and the second portion extend beyond the cavity to form the molded polymer joint in opposing directions.

12. The method according to claim 1, wherein the first and second portions both have at least one major surface, and wherein the major surfaces of the first and second portions are not completely covered by the molded polymer joint.

13-24. (canceled)

25. The method according to claim 1 wherein polymerizing the curable composition is at room temperature.

26. An assembly prepared according to the method of claim 1, the assembly comprising at least two articles bonded together through a molded joint.
